(19) United States
(12) Patent Application Publication
(10) Pub. No.: US 2006/0139156 A1
(43) Pub. Date: Jun. 29, 2006

(54) Bicycle proximity sensor system

(76) Inventor: Carl A. Beverly, El Sobrante, CA (US)

Correspondence Address: Ray K. Shahani, Esq.;ATTORNEY AT LAW, Twin Oaks Office Plaza, 477 Ninth Avenue, Suite 112, San Mateo, CA, 94402-1854, US

(21) Appl. No.: 11/011,680

(22) Filed: Dec. 14, 2004

(51) Int. Cl. B62J 6/00; G08G 1/095; G08G 1/02

(52) U.S. Cl. 340/432; 340/940; 340/907

(57) ABSTRACT

A bicycle proximity warning device comprising: a pressure tube positioned in the ground or on a paved path or roadway adjacent an area where bicyclists may be present; a pressure switch capable of creating and communicating an electrical signal upon application of a pressure pulse in the pressure tube caused by a cyclist crossing the pressure tube on a bicycle or other non-motorized vehicle; a timer circuit electrically connected to the pressure switch wherein upon receiving an electrical communication from the pressure switch, the timer circuit is activated for a predetermined period of time; and an illuminated signal portion electrically connected to the timer circuit wherein upon activation of the timer circuit, the signal portion is illuminated for the predetermined period of time the timer circuit is activated for.

### FIELD OF THE INVENTION

The present invention relates generally to a traffic warning system with for non-motorized vehicles, and more particularly, the present invention relates to traffic warning systems utilizing a warning light system to alert approaching motorists to the immediate presence of bicycles.

### BACKGROUND OF THE INVENTION

According to the National Highway Traffic Safety Administration (NBTSA), the first automobile crash in the United States occurred in New York city in 1896, in which a vehicle collided with a pedal-cycle.

It is reported that more than 47,000 pedal-cyclists have been killed in traffic accidents in the United States since 1932; which was the first year that the estimates of pedal-cyclist fatalities were reported. The 350 pedal-cyclist killed in 1932 accounted for 1.3 percent of the 27,979 persons killed in traffic accidents that year.

Some recent numbers reflect a distressing scenario of staggering number of traffic accidents relating to pedal-cyclists. In 2000, an unknown number of pedal-cyclists were injured in traffic crashes and an additional 51,000 were injured in traffic crashes. In 2001, 728 pedal-cyclists were killed and an additional 45,000 injured. In 2002, 662 pedal-cyclists were killed and an additional 48,000 were injured in traffic crashes. In 2002, 662 pedal-cyclists were killed and an additional 48,000 were injured in traffic crashes.

One of the main reasons for the high number of traffic accidents related casualties and injuries involving pedal-cycle riders is that there are increasing number of riders on the roads in recent years. Many people have adopted riding bicycles as an alternative mean of transportation to go to work and back. Additionally, more people have taken to riding bicycles as a form of recreation and sport enjoyment. As a result, there are more pedal-cycles and their riders on the roads to compete for roadway space that has usually been dominated by automobiles and/or other motorized vehicles. Like motorists, pedal-cyclists have the same legal responsibilities to obey traffic regulations. At the same time, pedal-cyclists also need to be protected and safe-guarded against accidents and injuries as motorists.

One attempt to address the need for better traffic safety on the roadways for pedal-cyclists comes in the form of the Inductive Loop Detectors. Many demand-actuated traffic signals feature a loop of wire buried in the pavement of the travel lane near the “Stop” line. The sensor, which is called inductive loop, works as a type of metal detector. There are several common shapes of inductive loop detectors, each with a different “sweet spot” for bicycles. The two most common shapes are the dipole loop and the quadrupole loop. These demand-actuated traffic signals can increase the efficiency of traffic flow, but cause problems when they fail to detect a waiting vehicle. Bicycles often have a difficulty being detected by the sensors because the sensors are improperly designed or adjusted.

Additionally, when a road is repaved over the loop sawcuts, a cyclist cannot determine the location of the sensor's wire and as a result may not be able to position the bike rims for detection.

However, none of the aforementioned devices can assist the bicyclist on the roadways where stretches of road are delineated with markings signifying a dedicated bike path.

In addition, the aforementioned device could not serve its intended purpose in hilly, areas and areas in which the roadway curves time and time again that are without dedicated bike lanes.

Video camera detectors are a new sensor technology in use at some traffic signals. These detector systems use digital image processing to detect a change in the image at a specific location in the travel lane due to the presence of a vehicle. To maximize the probability of detection, one stops one's bike in the center of the travel lane where other vehicles ordinarily stop when waiting for the signal. Turn the rider turns his or her body toward the camera to appear as large as possible. Video camera technology potentially allows a wider variety of vehicles to be detected than with inductive loop sensors, but the camera must be properly installed and adjusted for this to work.

### ADVANTAGES AND SUMMARY OF THE INVENTION

Accordingly, one object of the invention is to provide an easy and convenient way to alert motorized vehicle drivers of the presence of a pedal-cyclist in the immediate area ahead of the driver.

Another object of the invention is to provide a device that is easily installed on the shoulder of a road that may or may not have a dedicated bike path.

Still another object of the invention is to provide a highly visible and meaningful visual signal.

In addition, another object of the invention is to provide an early warning sign to vehicle drivers.

Thus, the present invention is a bicycle proximity warning device comprising a pressure tube positioned in the ground or on a paved path or roadway adjacent an area where bicyclists may be present; a pressure switch capable of creating and communicating an electrical signal upon application of a pressure pulse in the pressure tube caused by a cyclist crossing the pressure tube on a bicycle or other non-motorized vehicle; a timer circuit electrically connected to the pressure switch wherein upon receiving an electrical communication from the pressure switch, the timer circuit is activated for a predetermined period of time; and an illuminated signal portion electrically connected to the timer circuit wherein upon activation of the timer circuit, the signal portion is illuminated for the predetermined period of time the timer circuit is activated for.

The bicycle proximity sensor of the present invention further comprises an electrical power source coupled to the pressure switch, the timer circuit and the illuminated signal portion for providing electrical power as necessary.

The bicycle proximity sensor of the present invention, wherein the electrical power source further comprises a photovoltaic solar cell.

The bicycle proximity sensor of the present invention further comprises a battery with associated power charging and distribution management system in the electrical power source.

In a preferred embodiment of the present invention further comprises, the pressure tube is formed of rubber tubing.

The bicycle proximity sensor of the present invention further comprises a battery with associated power charging and distribution management system.

In a preferred embodiment of the present invention, wherein the illuminated signal portion comprises a warning light.

In a preferred embodiment of the present invention, wherein the illuminated signal portion comprises a symbol.

In a preferred embodiment of the present invention, wherein the illuminated signal portion comprises an image of a bicycle rider.

The bicycle proximity sensor of the present invention further comprises a audible warning system wherein an audible warning sounds for the predetermined period of time the timer circuit is activated for.

The bicycle proximity sensor of the present invention further comprises a central pole structure for suspending the illuminated warning signal portion at or somewhat above eye-level of passing motorists.

In a preferred embodiment of the present invention, wherein the illuminated signal portion comprises an enclosure for containing one or more light reflective surfaces.

The present invention is also a bicycle proximity warning device comprising: an inductive loop detector switch positioned in the ground or on a paved path or roadway, mounted on a pole or neighboring structure, or otherwise adjacent an area where bicyclists may be present capable of creating and communicating an electrical signal caused by a cyclist on a bicycle or other non-motorized vehicle; a timer circuit electrically connected to the inductive loop detector switch wherein upon receiving an electrical communication from the inductive loop detector switch, the timer circuit is activated for a predetermined period of time; an illuminated signal portion electrically connected to the timer circuit wherein upon activation of the timer circuit, the signal portion is illuminated for the predetermined period of time the timer circuit is activated for.

The present invention is also a method for providing a bicycle proximity warning to passing motorists on a paved path or roadway adjacent an area where bicyclists may be present utilizing a bicycle proximity warning system, the method comprising the following steps: detecting the proximity of a bicycle; activating a timer circuit for a predetermined period of time; providing a relay between the timer circuit and an illuminated warning signal portion; and illuminating the warning signal portion for the predetermined period of time the timer circuit is activated for.

In a preferred embodiment of the present invention, wherein the proximity of a bicycle is detected by actuation of a pressure sensor switch.

In a preferred embodiment of the present invention, wherein the proximity of a bicycle is detected by actuation of a pressure sensor switch caused by a bicycle crossing over a portion of pressurized rubber tubing.

In a preferred embodiment of the present invention, wherein the proximity of a bicycle is detected by a photoelectric sensor.

The present invention further comprises the following step: providing an inductive loop detector, wherein the proximity of a bicycle is detected by the inductive loop detector.

The present invention further comprises the following step: providing a source of power to the bicycle proximity warning system.

The present invention further comprises the following step: converting solar energy to electrical power for the bicycle proximity warning system.

Further objects and advantages of the present invention will be come apparent through the following descriptions, and will be included and incorporated herein.

### BRIEF DESCRIPTION OF THE DRAWINGS

FIG. 1A is a representative schematic view of a preferred embodiment of a non-motorized vehicle proximity sensor system 100 of the present invention.

FIG. 1B is a representative circuit diagram of a preferred embodiment of a non-motorized vehicle proximity sensor system 100 of the present invention.

FIG. 2 is a flowchart showing the method of use 200 of a non-motorized vehicle proximity sensor system 100 of the present invention

FIG. 3 is a top plan view of a preferred embodiment of a differential pressure switch 300 with connecting circuit of a non-motorized vehicle proximity sensor system 100 of the present invention.

FIG. 4A is a representative schematic view of a preferred embodiment of a warning light assembly 400 of a non-motorized vehicle proximity sensor system 100 of the present invention.

FIG. 4B is a representative front view of a preferred embodiment of a warning light 450 of a non-motorized vehicle proximity sensor system 100 of the present invention.

FIG. 4C is a representative exploded view of a preferred embodiment of a warning light 450 of a non-motorized vehicle proximity sensor system 100 of the present invention.

FIG. 4D is a representative front view of a preferred embodiment an alternative design of a warning light 460 of a non-motorized vehicle proximity sensor system 100 of the present invention.

FIG. 4E is a representative exploded view of a preferred embodiment of an alternative design of a warning light 460 of a non-motorized vehicle proximity sensor system 100 of the present invention.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

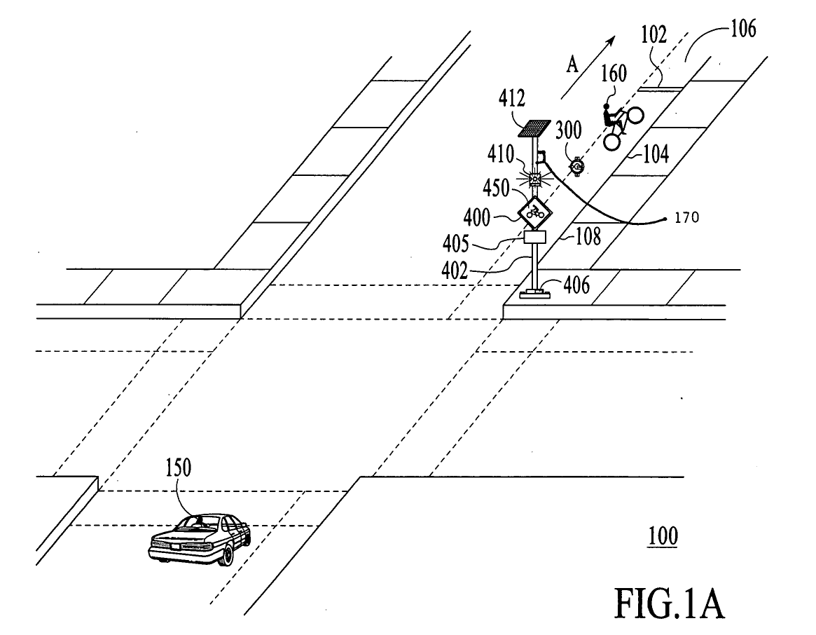

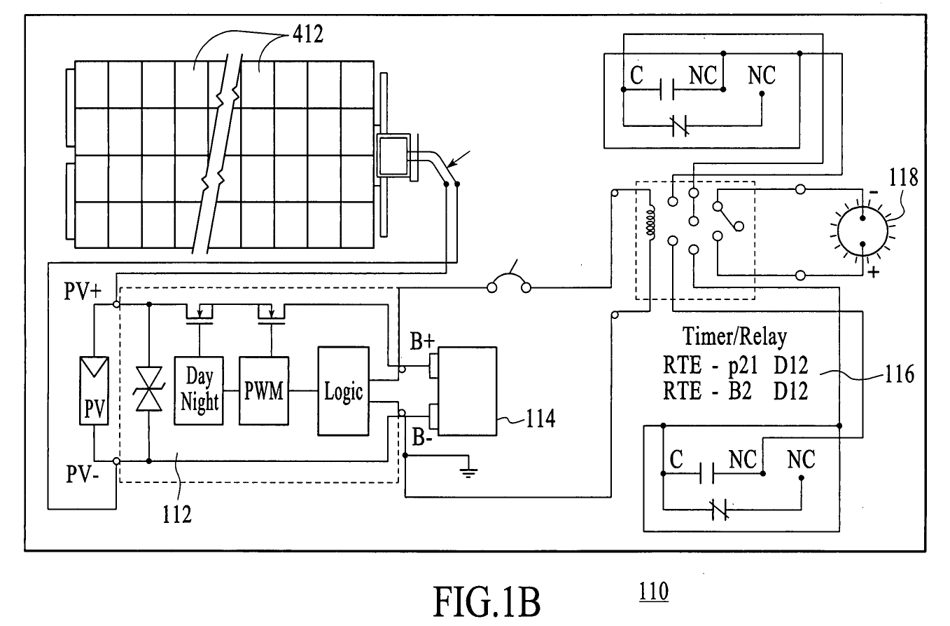

FIG. 1A is a representative schematic view of a preferred embodiment of a non-motorized vehicle proximity sensor system 100 of the present invention. As shown in FIG. 1A, in a preferred embodiment the non-motorized vehicle proximity sensor system 100 of the present invention comprises an external contact point 102, a pressure tubing circuit 104, one or more of differential pressure switches 300, electrical cable conduit 108 and a warning light assembly 400.

The main purpose of a non-motorized vehicle proximity sensor system 100 of the present invention is to warn motorists 150 and others that there is a non-motorized vehicle 160 in their immediate surrounding. In a preferred embodiment, the external contact point 102 is always installed ahead of the warning light assembly 400 along the traffic flow direction A. As shown in FIG. 1A, external contact point 102 comprises mainly a portion of pressure tube placing right on a roadway, bike lane and/or other predetermined locations. In a preferred embodiment, the pressure tube is a portion of rubber tube capable of accommodating barbed, slip-on type line connectors and connections. The pressure tube at external contact point 102 is connected to a pressure circuit 104 wherein pressure changes are detected and transmitted by a differential pressure switch 300. In a preferred embodiment, differential pressure switch 300 converts pneumatic and/or hydraulic signals generated at external contact point 102 to electrical and/or electronic signals. As shown in FIG. 1A, the electrical and/or electronic signal is then transmitted to the warning light assembly 400 via an electrical cable conduit 108. The warning light assembly 400 is then triggered and shows a warning light 410 and/or warning sign portion 450 to motorists 150.

In an alternative embodiment, a photoelectric sensor 170 can be installed on pole 402 of warning light assembly 400. The alternative embodiment could be a replacement and/or enhancement to the pressure tube circuit 104 embodiment. The installation and maintenance of a photoelectric sensor 170 does not involve any construction on the roads. Also, the photoelectric sensor 170 can be mounted on a pole 402, building or other structure as desired. Also, photoelectric sensors 170 can be installed to face up-road, down-road or angled to a particular location so as to suit road conditions and environment. In a preferred embodiment, photoelectric sensor 170 is selected from the Fiber Optic Photoelectric Sensors made by Grainger, or SA1E series Photoelectric Switches made by IDEC, Canada. The key features of IDEC SA1E series include four sensing methods, cable types and M8 connector types, NPN output, PNP output with light on, dark on options, long sensing ranges, high speed response and CE marked. In preferred embodiments, the photoelectric sensor 170 comprises a secondary, reflective portion, optionally located away from the sensor itself, thereby serving as a type of electric eye such as those found in grocery or other retail store doors, elevator doors, garage doors, etc.

FIG. 1B is a representative solar electronics and circuit diagram 110 of a preferred embodiment of a non-motorized vehicle proximity sensor system 100 of the present invention. The controller electronics 110 include solar cell and/or photovoltaic cell 412 electronics and controllers 112 and battery source 114. Also included is a timer relay 116 with interval selector knob 118.

In a preferred embodiment, solar electronics and circuit 110 comprises a controller similar to the SunGuard Solar Controller made by Morningstar Corporation, Washington Crossing, Pa. The present invention utilizes the most advanced, small economical solar charge controller available today. The SunGuard technology provides reliability, PWM battery charging, high quality and low cost. The SunGuard Solar Controllers are comparable in quality and performance to the leading SunSaver since they are made on the same high speed, automated production lines. They also both use the same charging circuit and the rest of components. SunGuard Solar Controllers are ISO 9002 qualified. They are series design and not shunt with 100% solid state. Also, they have a true 0-100% PWM duty cycle and setpoint accuracy to 60 mV. They are also temperature compensated, fully encapsulated in epoxy potting and have ABS plastic, impact-resistant case. They are rated for 25% overloads and there is no need to derate. They are outdoor rated with hypalon connecting wires and lightning protected with 1500 W transorbs. The electrical specifications are as follows:

Rated Solar input 4.5 A

Maximum Input (5 min) 5.5 A

System Voltage 12V

Maximum Solar Voltage 30V

Regulation Voltage 14.1 V

Accuracy 60 mV

Self-consumption 6 mA

Temperature Compensation −28 mV/° C.

Reverse Current Leakage <10 μA

Operating Temperature −40 to +85° C.

Alternatively, in a preferred embodiment, the solar electronics and circuit 110 comprise BP MSX-Lite modules designed for applications requiring a combination of light weight, compactness and ruggedness. There are 4 modules available viz. BP MSX-5 Lite, -10 Lite, -20 Lite and -30 Lite delivering nominal power of 4.5, 10, 20 and 30 watts respectively. All BP MSX-Lite modules are individually tested and provide limited warranty of power output for 5 years and freedom from defects in materials and workmanship for 1 year. They use multicrystalline silicon solar cells. Cells strings are laminated between sheets of ethylene vinyl acetate with a stainless steel substrate and Tedlar cover. The modules also use proven cell interconnection technique and moisture-resistant metallization to ensure electrical integrity in severe climates. BP MSX-Lite modules are compact and lightweight with the largest weight of 3 kg. The modules can be mounted from front or back through four grommet-finished holes which accept fasteners up to 5 mm diameter. The total thickness is 16 mm and the termination box is on the front to facilitate mounting on flat surfaces. The modules can also be mounted on gently curved surfaces since they can be bent without damage up to 8 cm/m. MSX-Lite modules are all tested and inspected in ISO 9001-certified factories to demanding specifications. Optionally, MSX-Lite modules come with an integral blocking discharge at night or during periods of poor insolation. The electrical characteristics of MSX-Lite modules are as follows:

Maximum Power (Pₘₐₓ)² 4.5 W-30 W

Voltage at Pₘₐₓ (Vₘₚ) 16.5V-16.8V

Current at Pₘₐₓ (Iₘₚ) 0.27 A-1.78 A

Warranted minimum Pₘₐₓ 4 W-27 W

Short-circuit current (I_{sc}) 0.3 A-1.94 A

Temperature coefficient of I_{sc} (0.065±0.015)%/° C.

Temperature coefficient of V_{oc} −(80±10)mV/° C.

Approximate effect of temperature on power −(0.5±0.05)%/° C.

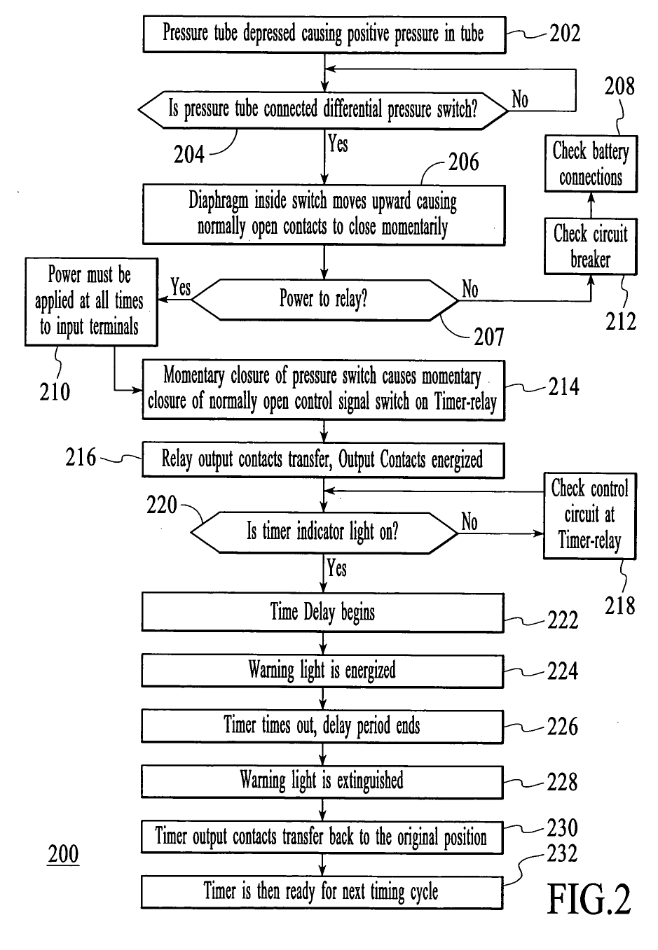

FIG. 2 is a flowchart showing the method of use 200 of a non-motorized vehicle proximity sensor system 100 of the present invention. The logistics of a non-motorized vehicle proximity sensor system 100 of the present invention are activated when a non-motorized vehicle 160 applies one or more pressure signals or impulses on the external contact point 102 of a pressure detector circuit 104. Depression of the pressurized tube portion at external contact point 102 causes positive pressure in pressure tube detector circuit 104, as shown in step 202.

Then, if pressure tube circuit 104 is connected to differential pressure switch 300, as shown in step 204, diaphragm 302 inside differential pressure switch 300 moves upward causing normally open contacts to close momentarily, as shown in step 206.

Then, the system will check whether there is power applied at all times to input terminals, as shown in step 210. If not, circuit breaker needs to be checked, as shown in step 212. Subsequently, battery connections need to be checked as well, as shown in step 208.

If power to relay is confirmed, as shown in step 207, the momentary closure of differential pressure switch 300 causes momentary closure of normally open control signal switch on timer-relay, as shown in step 214.

Subsequently, relay output contacts transfer and output contacts are energized, as shown in step 216.

Then, at step 220, it will check whether timer indicator light is on. If not, circuit at timer-relay should be checked, as shown in step 218. Otherwise, it will proceed to step 222 wherein time delay will begin.

Subsequently, as shown in step 224, the warning light assembly 400 is energized. And then, as shown in step 226, the timer times out and delay period will end. The warning light assembly 400 will then be extinguished, as shown in step 228.

Then, timer output contacts are transferred back to the original position, as shown in step 230. And finally, the timer is then ready for the next timing cycle as shown in step 232.

IN a preferred embodiment, timer relay 116 comprises an RTE Series Analog Timer part number RTE-81AD24m RTE-82Af20, etc., manufactured by RTE and distributed by Idec. Features of the RTE series include 20 time ranges and 10 timing functions, time delays up to 500 hours, space-saving package, high repeat accuracy of ±0.2%, ON and timing OUT LED indicators, standard 8 or 11-pin and 11-blade termination, 2 form C delayed output contacts and 10 A Contact Rating.

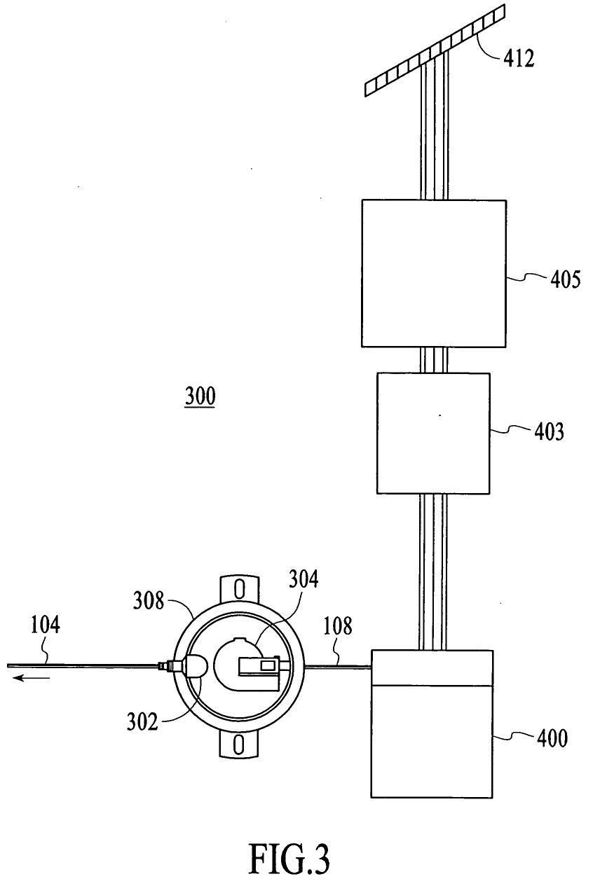

FIG. 3 is a top plan view of a preferred embodiment of a differential pressure switch 300 with connecting electrical circuit 110 of a non-motorized vehicle proximity sensor system 100 of the present invention. In a preferred embodiment, differential pressure switch 300 is an apparatus with a first part and a second part. The first part comprises of a diaphragm 302, the second part comprises of a snap-action switch 304. As shown best in FIG. 3, both diaphragm 302 and snap-action switch 304 are contained inside a thermoplastic housing 308. Diaphragm 302 is connected physically to pressure tubing circuit 104 on one end. The snap-action switch 304 is connected to electrical cable conduit 108 on the other end. The electrical connections consist of male/female quick connect terminals.

In a preferred embodiment of the present invention, during operation the actuating means include a pressure tubing circuit 104 attached to the pressure-sensitive differential pressure switch 300. In order to trigger differential pressure switch 300, positive pressure is exerted on diaphragm 302. The positive pressured diaphragm 302 causes the normally open contact in the second portion of the pressure switch, the snap-action switch 304, to make contact. Mechanical contact of the snap-action switch 304 closes a normally-open control signal switch on the timer relay. Consequently, the timer-relay of the differential pressure switch 300 is energized. The entire procedure can be explained in a flowchart form as shown in FIG. 2.

In a preferred embodiment, pressure switch 300 comprises Air Pressure Sensing Switch with Adjustable Set-Point, Model RSS-495-11 by Cleveland Controls, a Division of UniControl Inc. The Series RSS-495-11 air sensing switch kits contain compact economical switches designed for residential furnace and light commercial aftermarket applications. The RSS-495 switches have an adjustable set point range of 0.25″w.c. to 1.0″w.c. RSS-495 switches have thermoplastic housing contains a diaphragm and snap-acting switch. Barbed sample line connectors on each side of the diaphragm accept flexible tubing. The electrical connection consists of male quick connect terminals. The snap action switch can be actuated by a positive or negative pressure, or by a pressure differential. For secured mounting, a mounting location free from vibration should be selected. The diaphragm should be mounted in any vertical plane in order to maintain the specified operating set point. The RSS switches are equipped with two ¼″ barbed slip on sample line connections which are situated on either side of the diaphragm and can accept flexible tubing. The snap switch has male quick connect terminals. Before pressure is applied to the diaphragm, the switch contacts will be in the normally closed position. Reconnect existing wiring to the same terminals as the switch being replaced.

Another preferred embodiment of the air sensing switch 300 or similar is the Pneumatic Sensing Switch Model 3ZM95, and Switches with Field Adjustable Kits Models 3ZM96 and 3ZM97, all by Cleveland Controls and distributed by Grainger.com. 3ZM95 is pneumatic sensing switch with adjustable set point senses positive, negative, or differential air pressure. It can be used in HVAC and energy management applications where a pneumatic output signal for actuation is required, or in an intrinsically safe environment where electrical arcing must be avoided. The output pressure is fan on and air flow is 20 psig. The switch includes 6″poly tube, 2 slip-on tubing adapters, and mounting screws. 3ZM96 and 3ZM97 are both switches with field adjustable kits which may be used to sense positive, negative, or differential air pressure. They are UL listed and CSA certified. The main use of these models are for residential and mid-efficiency furnaces as well as light commercial applications. The electrical rating

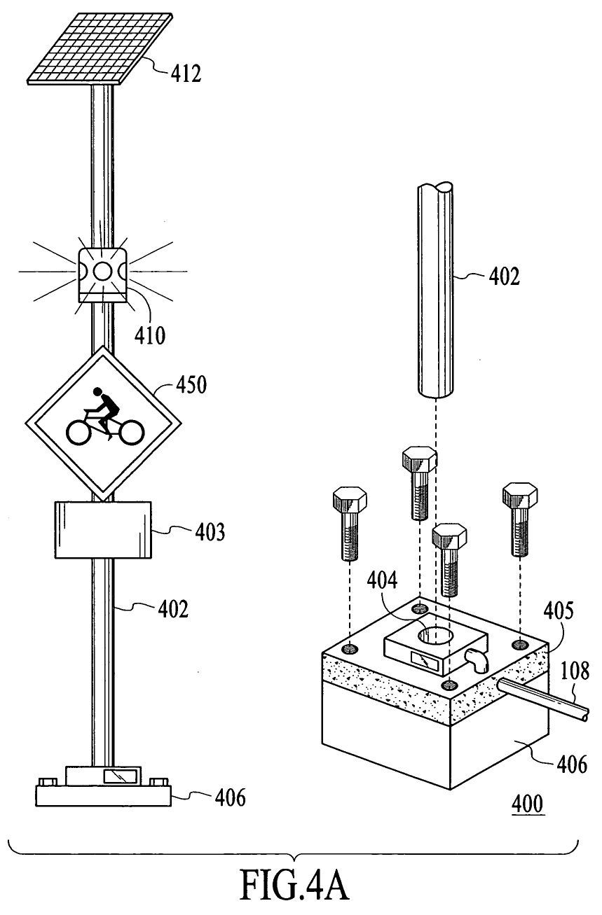

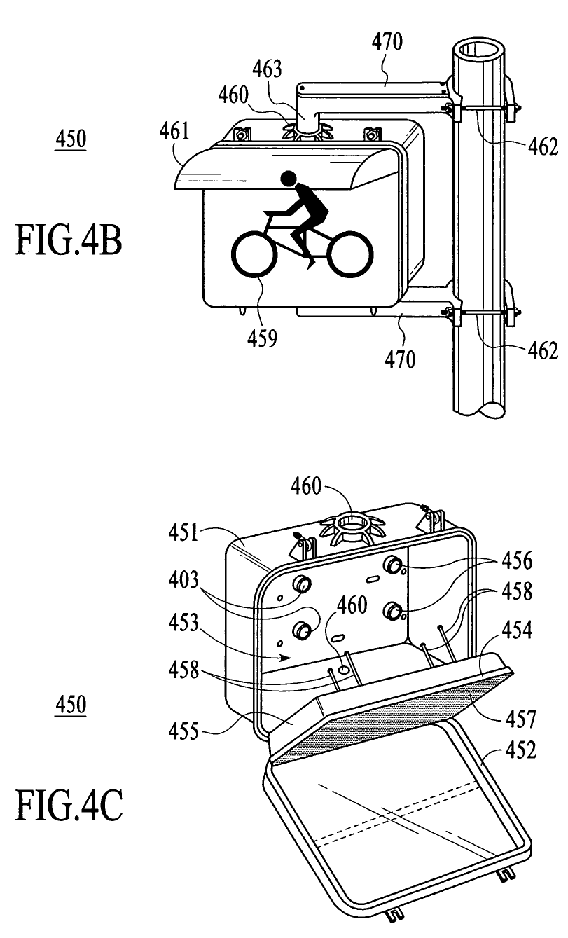

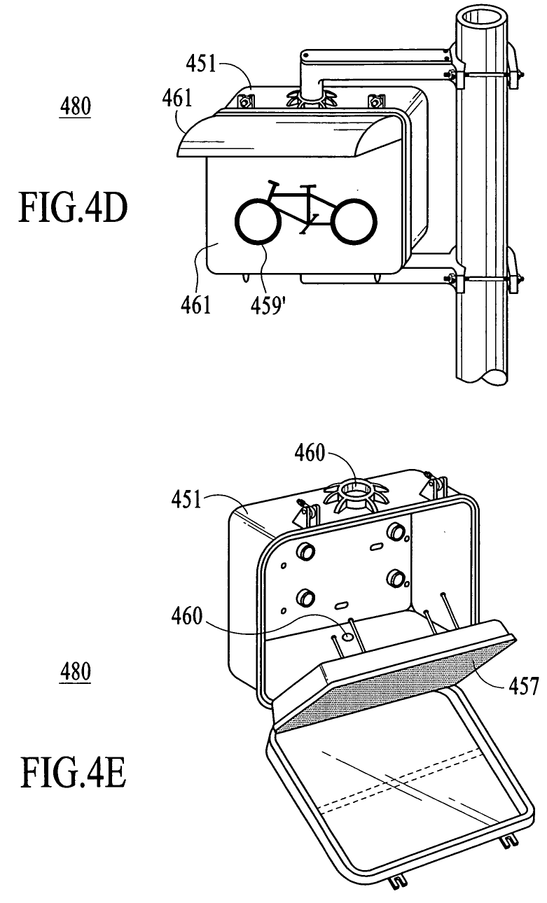

FIG. 4A is a representative schematic view of a preferred embodiment of a warning light assembly 400 of a non-motorized vehicle proximity sensor system 100 of the present invention. As shown in FIGS. 1A and 4A, the warning light assembly 400 mainly comprises of photo cell 412, warning light 410, non-motorized vehicle warning signal 450 portion, pole 402, electric box 403 and base mount 406.

Base mount 406 is partially imbedded on the ground in order to gain leverage and stability. In a preferred embodiment, it also provides room to house solar cell electronics and controller circuit 110. A base plate 405 is placed on top of base mount 406 in order to accommodate pole 402. Base plate 405 is secured on base mount 406 by a plurality of screws (shown) with length in a range of 6″ to 8″. As shown in FIG. 4A, electrical cable conduit 108 enters base mount on its side and subsequently connects to solar electronics and controller circuit 110. Pole 402 is the main post to support the entire structure of the warning light assembly 400. In a preferred embodiment, pole 402 is a partially hollow tubular structure that is erected at opening 404 on base plate 405 of base mount 406. The hollow structure of pole 402 allows room for electrical wiring circuits running through it.

In a preferred embodiment, the photovoltaic cell 412 is secured at the very top of warning light assembly 400 in order to be exposed to the maximum amount of solar produced photo-energy. Photovoltaic cell 412, alternatively referred to herein as photo cell or PV cell, is the sole, primary or back-up source of energy for warning light 410 and non-motorized vehicle warning signal portion 450 and is controlled by solar electronics and controller circuit 110.

In a preferred embodiment, electric box 403 is secured around pole 402 below non-motorized vehicle warning signal 450. The function of electric box 403 is to contain electrical circuit 110, other electronics or controllers and for general access, repairs and maintenance of the system.

FIG. 4B is a representative front view of a preferred embodiment of a warning signal 450 of a bicycle/non-motorized vehicle proximity sensor system 100 of the present invention. FIG. 4C is a representative exploded view of a preferred embodiment of a warning signal 450 of a bicycle/non-motorized vehicle proximity sensor system 100 of the present invention.

As shown in FIGS. 4B and 4C, warning signal 450 comprises a rectangular housing 454 sized to be fitted inside a rectangular case 451. In a preferred embodiment, the rectangular case 451 comprises an open front 452 and compartment 453. The open front 452 further comprises a pattern portion 459 which is transparent/translucent. The compartment 453 further comprises a reflective rear wall 455. The reflective rear wall 455 is a light reflective surface which is designed such that incoming light is essentially entirely reflected to a single focal point inside compartment 453 without escaping through open front 459. As shown in FIG. 4C, in a preferred embodiment, the reflective rear wall 455 further comprises one or more power socket(s) 456 which are connected to a power source. The rectangular housing 454 further comprises light emitting diodes 457. The light emitting diodes 457 are provided with power legs 458 which are in contact with power socket 456 and are configured in both horizontal and vertical planes. In a preferred embodiment, the light source of light emitting diodes 457 are PN junction devices that give off light radiation that is biased towards the forward direction.

When light emitting diodes 457 are operating, all of the emitting light is directed outward through the pattern portion 459 of the open front 452. Henceforth, a pattern according to the design of pattern portion 459 is illuminated. In a preferred embodiment, the design is a bicycle and rider international symbol, as best shown in FIG. 4B. When light emitting diodes 457 are off, any light entering through the pattern portion 459 of the open front 452 is reflected to the focal point and is trapped/scattered inside the compartment 453.

As shown in FIG. 4A, the rectangular case 451 further comprises a visor 461 to be mounted over the open front 452 to shield the open front 452 from sunlight. In a preferred embodiment, the entire the rectangular case 451 is mounted to a pair of mast arm brackets 470 at mounting holes 460 which are located at the top and bottom of the rectangular case 451. An integral protuberance 463 at the distal end of the mast arm brackets 470 and the protuberance 463 extend into mounting holes 460 in the upper and lower sides of the rectangular case 451. The protuberance 463 is attached to the sides of the rectangular case 451 with appropriate side mounting hardware in accordance with signal lighting, and signal head and mounting standards. Such standards, incorporated herein in their entireties, include but are not limited to ASTME, US-DOT, etc. In a preferred embodiment, mast arm brackets 470 are then clamped and secured on pole 402 at grooves 462.

FIG. 4D is a representative front view of a preferred embodiment an alternative design of a non-motorized vehicle warning signal 480 of a non-motorized vehicle proximity sensor system 100 of the present invention. FIG. 4E is a representative exploded view of a preferred embodiment of an alternative design of non-motorized vehicle warning signal 480 of a non-motorized vehicle proximity sensor system 100 of the present invention.

As shown in FIGS. 4D and 4E, different designs can be accommodated by merely changing the design of the pattern portion 459 of the open front 452 without major altering of the rest of the structure of a warning signal 480 of a bicycle/non-motorized vehicle proximity sensor system 100 of the present invention. In an alternative embodiment, the design is a bicycle symbol, as best shown in FIG. 4D.

In preferred embodiments, electrical boxes 403 and 406 and enclosure 451 comprises NEMA 3R Rain Tight Steel Electrical Boxes such as Model 7649K51, 52, 53, 54 or 55, supplied by McMaster-Carr Supply Company. These boxes are for indoor and outdoor use and are made from 16 gauge gray finish galvanized steel. Those models have drip shield top and smooth sides both on front and back. And all models meet UL 50 Type 3R, IEC 529, IP 32. The screw cover model has two captive screws in front. Mounting of components is done on the front so no panels are required. The hinge cover model has galvanized steel, heavy gauge continuous hinge on the left side and captive screws. A hasp and staple are provided for padlocking and panels are included.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A bicycle proximity warning device comprising:
a pressure tube positioned in the ground or on a paved path or roadway adjacent an area where bicyclists may be present;
a pressure switch capable of creating and communicating an electrical signal upon application of a pressure pulse in the pressure tube caused by a cyclist crossing the pressure tube on a bicycle or other non-motorized vehicle;
a timer circuit electrically connected to the pressure switch wherein upon receiving an electrical communication from the pressure switch, the timer circuit is activated for a predetermined period of time; and
an illuminated signal portion electrically connected to the timer circuit wherein upon activation of the timer circuit, the signal portion is illuminated for the predetermined period of time the timer circuit is activated for.

2. The bicycle proximity sensor of claim 1, further comprising an electrical power source coupled to the pressure switch, the timer circuit and the illuminated signal portion for providing electrical power as necessary.

3. The bicycle proximity sensor of claim 2, wherein the electrical power source comprises a photovoltaic solar cell.

4. The bicycle proximity sensor of claim 3, further comprising a battery with associated power charging and distribution management system.

5. The bicycle proximity sensor of claim 1, wherein the pressure tube is formed of rubber tubing.

6. The bicycle proximity sensor of claim 1, further comprising a battery with associated power charging and distribution management system.

7. The bicycle proximity sensor of claim 1, wherein the illuminated signal portion comprises a warning light.

8. The bicycle proximity sensor of claim 1, wherein the illuminated signal portion comprises a symbol.

9. The bicycle proximity sensor of claim 1, wherein the illuminated signal portion comprises an image of a bicycle rider.

10. The bicycle proximity sensor of claim 1, further comprising a audible warning system wherein an audible warning sounds for the predetermined period of time the timer circuit is activated for.

11. The bicycle proximity sensor of claim 1, further comprising a central pole structure for suspending the illuminated warning signal portion at or somewhat above eye-level of passing motorists.

12. The bicycle proximity sensor of claim 1, wherein the illuminated signal portion comprises an enclosure for containing one or more light reflective surfaces.

13. A bicycle proximity warning device comprising:
an inductive loop detector switch positioned in the ground or on a paved path or roadway, mounted on a pole or neighboring structure, or otherwise adjacent an area where bicyclists may be present capable of creating and communicating an electrical signal caused by a cyclist on a bicycle or other non-motorized vehicle;
a timer circuit electrically connected to the inductive loop detector switch wherein upon receiving an electrical communication from the inductive loop detector switch, the timer circuit is activated for a predetermined period of time;
an illuminated signal portion electrically connected to the timer circuit wherein upon activation of the timer circuit, the signal portion is illuminated for the predetermined period of time the timer circuit is activated for.

14. A method for providing a bicycle proximity warning to passing motorists on a paved path or roadway adjacent an area where bicyclists may be present utilizing a bicycle proximity warning system, the method comprising the following steps:
detecting the proximity of a bicycle;
activating a timer circuit for a predetermined period of time;
providing a relay between the timer circuit and an illuminated warning signal portion; and
illuminating the warning signal portion for the predetermined period of time the timer circuit is activated for.

15. The method of claim 14, wherein the proximity of a bicycle is detected by actuation of a pressure sensor switch.

16. The method of claim 14, wherein the proximity of a bicycle is detected by actuation of a pressure sensor switch caused by a bicycle crossing over a portion of pressurized rubber tubing.

17. The method of claim 14, wherein the proximity of a bicycle is detected by a photoelectric sensor.

18. The method of claim 14, further comprising the following step:
providing an inductive loop detector, wherein the proximity of a bicycle is detected by the inductive loop detector.

19. The method of claim 14, further comprising the following step:
providing a source of power to the bicycle proximity warning system.

20. The method of claim 19, further comprising the following step:
converting solar energy to electrical power for the bicycle proximity warning system.
